(19) United States
(12) Patent Application Publication
(10) Pub. No.: US 2023/0131454 A1
(43) Pub. Date: Apr. 27, 2023

(54) METHOD FOR MANUFACTURING LITHIUM ION BATTERIES

(71) Applicant: HFG, Dardilly (FR)

(72) Inventor: Fabien GABEN, Dardilly (FR)

(21) Appl. No.: 17/907,444

(22) PCT Filed: Mar. 30, 2021
(86) PCT No.: PCT/IB2021/052606

§ 371 Date: Sep. 27, 2022

(30) Foreign Application Priority Data
Mar. 30, 2020 (FR) 2003108

(51) Int. Cl. H01M 10/0525; H01M 10/058; H01M 50/403; H01M 4/04; H01M 50/491

(52) U.S. Cl. CPC H01M 10/0525; H01M 10/058; H01M 50/403; H01M 4/0457; H01M 4/0409; H01M 50/491

(57) ABSTRACT

A method for manufacturing a lithium ion battery with a capacitance greater than 1 mA h, including the deposition of at least one dense layer, which can be an anode and/or a cathode and/or an electrolyte, by a method of depositing a dense layer. The method includes: supplying a substrate and a suspension of non-agglomerated nanoparticles of a material P; depositing a layer on the substrate using the suspension; drying the layer thus obtained; densifying the dried layer by mechanical compression and/or heat treatment. The method of depositing being characterised in that the suspension of non-agglomerated nanoparticles of material P includes nanoparticles of material P having a size distribution, said size being characterised by the value of D50 thereof, such that: the distribution includes nanoparticles of material P of a first size D1 between 20 nm and 50 nm, and nanoparticles of material P of a second size D2 characterised by a value D50 at least five times less than that of D1, or the distribution has a mean size of nanoparticles of material P less than 50 nm, and a standard deviation to mean size ratio greater than 0.6.

### CROSS-REFERENCE TO RELATED APPLICATION

The present application is a National Stage Application of PCT International Application No. PCT/IB2021/052606 (filed on Mar. 30, 2021), under 35 U.S.C. § 371, which claims priority to French Patent Application No. FR 2003108 (filed on Mar. 30, 2020), which are each hereby incorporated by reference in their complete respective entireties.

### TECHNICAL FIELD

The present invention relates to the manufacture of dense layers, suitable for use as a layer of electrodes or electrolytes in electrochemical devices and multilayer batteries, such as lithium ion batteries. More precisely, the invention relates to a novel method for manufacturing these dense layers from inorganic nanoparticles, which can optionally have received a functionalisation with a layer of organic coating, which can be polymeric.

The invention also relates to multilayer batteries incorporating at least one dense layer obtained with this method, this layer able in particular to act as an electrode in a lithium ion battery.

The invention also relates to a novel method for manufacturing lithium ion batteries, wherein at least one dense electrode layer is deposited using the novel method for manufacturing dense layers, and wherein a porous layer is also deposited.

### BACKGROUND

The ideal battery for powering autonomous electrical devices (such as: portable telephones and computers, portable tools, autonomous sensors) or for the traction of electric vehicles would have a high service life, would be able to store both large quantities of energy and power, and would not have the risk of overheating or even exploding.

Currently, these electrical devices are essentially powered by lithium ion batteries, which have the best energy density of the different storage technologies proposed. There are different architectures and chemical compositions of electrodes for producing lithium ion batteries. The methods for manufacturing lithium ion batteries are described in numerous articles and patents, and the publication “Advances in Lithium-Ion Batteries” (ed. W. van Schalkwijk and B. Scrosati), published 2002 (Kluever Academic/Plenum Publishers) gives a good overview.

Lithium ion battery electrodes can be manufactured using coating techniques (particularly: roll coating, doctor blade coating, tape casting, slot-die coating). With these methods, the active materials serving to produce the electrodes are in the form of powders wherein the mean particle size is situated between 5 and 15 μm in diameter. These particles are incorporated in an ink which is formed from these particles and deposited on the surface of a substrate.

These techniques make it possible to produce layers of a thickness between about 50 μm and about 400 μm. According to the thickness of the layers, the porosity thereof and the size of the active particles, the power and the energy of the battery can be modulated.

The inks (or pastes) deposited to form the electrodes contain active material particles, but also binders (organic), carbon powder for providing electrical contact between particles, and solvents which are evaporated during the electrode drying step. To improve the quality of the electrical contacts between the particles and to compact the deposited layers, a calendaring step is performed on the electrodes. After this compression step, the active particles of the electrodes occupy about 60% of the deposition volume, which means that 40% porosities generally remain between the particles.

The contact between each of the particles is essentially in point form and the structure of the electrode is porous. The porosities are filled with an electrolyte, which can be liquid (aprotic solvent wherein a lithium salt is dissolved) or in the form of more or less polymerised gel impregnated with a lithium salt. The thickness of lithium ion battery electrodes being generally between 50 μm and 400 μm, the lithium ions are transported in the thickness of the electrode via the porosities which are filled with electrolyte (containing lithium salts). According to the quantity and size of the porosities, the diffusion rate of lithium in the thickness of the electrode varies.

To ensure proper operation of the battery, the lithium ions must diffuse both in the thickness of the particle and in the thickness of the electrode. The diffusion in the particle of active material is slower than in the electrolyte with which the porous electrode is impregnated: this electrolyte is liquid or gelled. The slow diffusion in the electrode particles contributes to the serial resistance of the battery. Also, to achieve a satisfactory battery power, the particle size must be reduced; in standard lithium ion batteries, it is situated typically between 5 μm and 15 μm.

Moreover, according to the thickness of the layers, the size and density of active particles contained in the ink, the power and the energy of the battery can be modulated. The energy density is necessarily increased to the detriment of the power density. High-power battery cells must use electrodes and separators of small thickness and high porosity, whereas increasing the energy density requires, on the other hand, an increase in these same thicknesses and a reduction in the porosity rate. The article “Optimization of Porosity and Thickness of a Battery Electrode by Means of a Reaction-Zone Model” by John Newman, published in J. Electrochem. Soc., Vol. 142, No.1 in January 1995, demonstrates the respective effects of the thicknesses of the electrodes and the porosity thereof on the discharge rate (power) and energy density thereof.

However, increasing the porosity in the electrodes tends to degrade the energy density of the battery: to increase the energy density of the electrodes, it is necessary to reduce the porosity. In current lithium ion batteries, it is essentially the porosities filled with electrolyte situated between the active particles which make it possible to diffuse the lithium ions in the electrode. In the absence of porosities filled with electrolyte, the lithium ions are transported from one particle to the other at the contacts between the particles, this contact being substantially in point form. Thus, the lithium ion transport resistance is such that the battery cannot function.

Furthermore, to function properly, the porosities of the electrodes must be filled with electrolyte. This filling is only possible if these porosities are open. Furthermore, according to the size of the porosities and the tortuosity thereof, impregnating the electrode with the electrolyte can become very difficult, or even impossible. When the porosity rate, impregnated with electrolyte, decreases, the electrical resistance of the layer decreases and the ionic resistance thereof increases. When the porosity falls below 30% or even 20%, the ionic resistance increases significantly as some porosities are then capable of closing again, which prevents the wetting of the electrode by the electrolyte.

Consequently, once it is sought to produce electrode films with no porosities to increase the energy density, it is necessary to limit the thickness of these films to less than 50 μm, and preferably less than 25 μm, in order to enable the rapid diffusion of the lithium ions in the solid, with no loss of power.

To produce dense films, the main process used consists of depositing by means of a vacuum method a film of lithium insertion electrode material. This technique makes it possible to obtain dense films, without porosities, or binders, and having accordingly excellent energy densities, and a satisfactory temperature behaviour.

The absence of porosities makes it possible to transport the lithium ions by diffusion through the film, without having to use organic electrolytes based on polymers or solvent containing lithium salts.

Such completely inorganic films provide excellent performances in terms of ageing, safety and temperature behaviour.

PVD (Physical Vapour Deposition) is the currently the most commonly used technology for manufacturing microbatteries in thin layers. Indeed, these products requires films free from porosities and other point defects to ensure a low electrical resistivity, and the proper ionic conduction required for the proper operation of the electrochemical devices.

The deposition rate obtained with such technologies is of the order of 0.1 μm to 1 μm per hour. PVD deposition techniques make it possible to obtain films of very high quality, containing virtually no point defects, and make it possible to carry out depositions at relatively low temperatures. However, due to the difference in evaporation rate between the different elements, it is difficult to deposit complex compounds with such techniques, and control the stoichiometry of the layer. This technique is perfectly suitable for producing thin layers of simple chemical composition, but once it is sought to increase the deposition thickness the deposition time becomes too great to envisage industrial use in the field of low-cost products.

Furthermore, the vacuum deposition techniques used to produce such films are very costly and difficult to implement industrially on large surface areas, with a high productivity.

The other technologies currently available to produce dense ceramic films, comprise embodiments based on the densification of compact particle depositions or indeed obtaining film using sol-gel type techniques. Sol-gel techniques consist of depositing on the surface of a substrate a polymeric lattice obtained after hydrolysis, polymerisation and condensation steps. The sol-gel transition occurs during the evaporation of the solvent which accelerates the reaction processes on the surface. This technique makes it possible to produce very thin compact depositions. The films thus obtained have a thickness of the order of about one hundred nanometres. These thicknesses are then too small to enable reasonable energy storage in battery applications.

To increase the deposition thickness without giving rise to the risk of onset of cracks or crazing, it is necessary to proceed with successive steps. However, this lowers the industrial productivity of this technique, once it is sought to increase the thickness of the layers.

It is also possible to produce ceramic electrode and/or electrolyte films for batteries by powder sintering. For this, a paste containing ceramic particles and organic binders are placed in film form to obtain a precursor strip commonly known as “green-sheet”.

This precursor strip is then calcined to remove the organic matter and sintered at a high temperature to obtain a sheet of ceramic material.

In this case, the metallic films serving to collect current on these electrodes are also deposited using inking techniques. The metallic powders will also be sintered at the same time as the “green-sheet”. Indeed, during the sintering step, the porosities between the particles of ceramic material will be filled, which will result in a shrinking of the strip.

Sintering the current collectors with the ceramic films makes it possible to accommodate the dimensional variations of the ceramic films and metallic collectors and prevent the onset of cracks.

These methods operate at very high temperatures. However, battery materials are generally temperature-sensitive and are rapidly degraded when subjected to such heat treatments.

In order to lower this sintering temperature, the use of nanoparticles has been proposed. In this case, it consists of producing compact depositions of non-agglomerated nanoparticles. These depositions can be readily sintered at relatively low temperatures. This low temperature makes it possible to envisage carrying out sintering directly on metallic substrates.

However, it is observed that these depositions, when they are produced on metallic substrates, are conducive, depending on the thickness of the deposition, the compactness thereof, the particle size, to the onset of cracks during the drying and/or sintering steps.

Electrophoretic nanoparticle deposition techniques have been used to increase the compactness of the depositions and thus facilitate low-temperature sintering with fewer cracks; this is described in several patent applications, for example WO 2013/064773, WO 2013/064776, WO 2013/064777 and WO 2013/064779 (Fabien Gaben). Thermal coalescence is carried out at a temperature which is especially low as the nanoparticle size is small, and in practice preferably less than 100 nm.

### SUMMARY

The present invention seeks to remedy at least in part the drawbacks of the prior art mentioned above.

More specifically, the problem addressed by the present invention is that of providing a method for manufacturing dense ceramic layers, directly on a metallic substrate, which is simple, safe, quick, easy to implement, inexpensive.

The aim of the present invention is also that of producing dense solid (ceramic) layers, suitable for lithium ion batteries, containing no or very few defects and porosity.

The aim of the present invention is also that of providing dense electrodes and dense electrolytes having a high ionic conductivity, a stable mechanical structure, a good thermal stability and a long service life.

A further aim of the invention is that of providing a method for manufacturing an electronic, electrical or electrotechnical device such as a battery, a capacitor, a supercapacitor, a photovoltaic cell comprising a dense electrode or a dense electrolyte according to the invention.

According to the invention, the problem is solved by a method for manufacturing a lithium ion battery with a capacitance greater than 1 mA h, said method comprising the deposition of at least one dense layer, which can be an anode and/or a cathode and/or an electrolyte, by a method of depositing a dense layer that comprises the steps of:
supplying a substrate and a suspension of non-agglomerated nanoparticles of a material P,
depositing a layer, on said substrate, using the suspension of primary nanoparticles of a material P;
drying the layer thus obtained,
densifying the dried layer by mechanical compression and/or heat treatment, knowing that the drying step and the densification step can be performed at least partially at the same time, or during a temperature ramp.

Said method, which forms a first aim of the present invention, is characterised in that the suspension of non-agglomerated nanoparticles of material P comprises nanoparticles of material P having a specific size distribution, making it possible to obtain a density greater than 75% after deposition. Said size is characterised by the D₅₀ value thereof.

This particle size distribution can be obtained either:
continuously: In this case, the ratio of standard deviation/mean size of the nanoparticles of material P must be greater than 0.6, and the mean size of the primary nanoparticles of material P less than or equal to 50 nm; or
discontinuously: in this case, the size distribution of the nanoparticles of material P comprises nanoparticles of a first size D1 between 50 nm and 20 nm, and nanoparticles of a second size D2 at least five times less than that of D1. Very advantageously, the particles of size D1 represent between 50 and 75% of the total mass of nanoparticles.

Said suspension of non-agglomerated nanoparticles of material P can be obtained using a monodisperse suspension of size D1, and/or said suspension of nanoparticles of size D2 can be obtained using a monodisperse suspension.

According to the invention, the deposition of the solid and dense ceramic layer is performed electrophoretically, by the dip-coating method, by the ink jet printing method, by roll coating, by slot-die coating, by curtain coating, or by doctor blade coating.

After deposition, the dried layer has a density greater than 75%, thanks to the particle size distribution of the constituent nanoparticles thereof. This density can be increased further by a step of densifying the dried layer, by mechanical compression and/or by a heat treatment.

A second aim of the invention is a dense layer in a battery with a capacitance greater than 1 mA h (and preferably a lithium ion battery with a capacitance greater than 1 mA h), said dense layer being capable of being obtained with the method according to the invention. Said dense layer can particularly an anode layer, a cathode layer and/or an electrolyte layer.

A third aim of the invention is a lithium ion battery with a capacitance greater than 1 mA h, able to be obtained by this method. Said battery therefore comprises at least one dense layer, that can be an anode layer, a cathode layer and/or an electrolyte layer.

This dense anode layer and/or this dense cathode layer can have a thickness between about 1 μm and about 50 μm.

In an embodiment, said lithium ion battery comprises an anode and a cathode which are dense layers according to the invention.

In a first variant, the electrolyte layer can also be a dense layer according to the invention. In a second variant, said battery comprises a porous separator that separates said anode and said cathode; this porous separator is infiltrated by a liquid electrolyte. This electrolyte layer or this separator has advantageously a thickness between about 1 μm and about 25 μm, and preferably between about 3 μm and about 10 μm.

In a further embodiment, only the electrolyte layer thereof is a dense layer according to the invention.

### DESCRIPTION

Within the scope of the present document, the size of a particle is defined by the greatest dimension thereof. The term “nanoparticle” denotes any particle or object of nanometric size having at least one of the dimensions thereof less than or equal to 100 nm. This size D is expressed here as the size D50.

The term “nanoparticle” is used here to denote primary particles, as opposed to particles formed by aggregation or agglomeration of several primary particles. Such agglomerates can be reduced to nanoparticles (in the sense understood here) by a dispersion operation, for example by grinding or ultrasonic treatment.

The density of a layer is expressed here as a relative value (for example in percent), which is obtained by comparing between the actual density of the layer (designated here as dlayer) and the theoretical density of the constituent solid material (designated here as dtheoretical). Thus, the porosity of the layer, expressed in percent, is determined as follows:

Porosity[%]=[(d_{theoretical}−d_{layer})/d_{theoretical}]×100.

According to the invention, the problem is solved by a method for depositing a layer using a nanoparticle suspension, wherein the size of the nanoparticles has a particle size distribution of a particular type.

According to one of the essential aspects of the invention, a nanoparticle suspension is used which represents a particular nanoparticle size distribution, in such a way as to significantly increase the density of the deposition of nanoparticles before sintering.

Obtaining the most compact deposition possible before sintering will make it possible to reduce the shrinking and the risk of cracking. In order to obtain the most compact deposition possible, it is not only necessary to perfectly control the nanoparticle size distribution but also to have the most compact deposition possible of these nanoparticles, without agglomeration.

To obtain such compact depositions, it is possible to either use electrophoretic deposition techniques of dilute suspensions, or indeed deposition techniques of non-agglomerated concentrated suspensions of these polydisperse nanoparticles, by inking, dip-coating, curtain coating, doctor blade, slot-die, etc. Obtaining such concentrated suspensions requires the use of stabilisers, which are organic ligands (for example of PVP type), in order to prevent agglomeration phenomena between nanoparticles. These ligands will be removed at the start of the sintering heat treatment: typically, an intermediate thermal ramp is completed in order to remove all these organic compounds before sintering.

The viscosity of the suspension used for deposition is essentially dependent on the nature of the liquid phase (solvent), the size of the particles and the concentration thereof (expressed by the dry extract). The viscosity of the suspension, as well as the parameters of the deposition method (particularly the travel speed or the passage speed in the liquid) determine the thickness of the deposition. According to these parameters inherent to the deposition technique, the viscosity generally used for dip coating, curtain coating or slot-die coating can vary widely and is situated between about 20 cP and about 2000 cP, measured at 20° C. A colloidal suspension intended to carry out a deposition is frequently referred to as an “ink”, regardless of the viscosity thereof.

Once these organic compounds have been removed, the nanoparticles will come into contact and commence the consolidation process. The surfaces of the nanoparticles will weld together at the contact points; this phenomenon is known as “necking” (neck formation). During sintering, these contact points which have become welding zones will increase by diffusion, until they fill the voids left by the initial porosity of the deposition. The filling of these voids is the cause of the shrinking.

In addition, to obtain a final porosity rate less than 15%, preferably less than 10%, on the thick depositions produced on metallic substrates with no cracks, it is necessary to maximise the compactness of the initial nanoparticle deposition, while retaining the nanometric effect which makes it possible to reduce the consolidation temperatures and keep them compatible with the use of metallic substrates.

According to the invention, colloidal nanoparticle suspensions are used wherein the mean nanoparticle size does not exceed 100 nm. These nanoparticles have moreover a relatively broad size distribution. When this size distribution observes an approximately Gaussian distribution, then the ratio (sigma/Rₘₑₐₙ) of the standard deviation over the mean radius of the nanoparticles must be greater than 0.6.

To increase this compactness of the initial deposition before sintering, it is also possible to use a mixture of two nanoparticle size populations. In this case, the mean diameter of the greatest distribution should not exceed 100 nm, and preferably not exceed 50 nm. This first population of the largest nanoparticles may have a narrower size distribution with a sigma/Rₘₑₐₙ ratio less than 0.6. This population of “large” nanoparticles should represent between 50% and 75% of the dry extract of the deposition (expressed as a mass percentage with respect to the total mass of nanoparticles in the deposition). The second population of nanoparticles will consequently represent between 50% and 25% of the dry extract of the deposition (expressed as a mass percentage with respect to the total mass of nanoparticles in the deposition). The mean diameter of the particles of this second population should be at least 5 times smaller than that of the largest nanoparticle population. As for the largest nanoparticles, the size distribution of this second population may be narrower and with potentially a sigma/Rₘₑₐₙ ratio less than 0.6.

It is preferred that the mean diameter of the second population is at least one fifteenth of the largest nanoparticle population, and preferably at least one twelfth; this facilitates the densification of the layer after the deposition thereof.

In any case, the two populations should show agglomeration in the ink produced. In addition, these nanoparticles can be advantageously synthesised in the presence of ligands or organic stabilisers so as to prevent aggregation or agglomeration of the nanoparticles.

The preparation of colloidal suspensions by wet nanogrinding makes it possible to obtain relatively broad size distributions. However, according to the nature of the ground material, the “fragility” thereof, the reduction factor applied, the primary nanoparticles can be damaged or amorphised.

The materials used in manufacturing lithium ion batteries are particularly sensitive, the slightest modification of the crystalline state thereof or of the chemical composition thereof results in degraded electrochemical performances. In addition, for this type of application, it is preferable to use nanoparticles prepared in suspension directly by precipitation, according to solvothermal or hydrothermal type methods, at the desired primary nanoparticle size.

These methods for synthesising nanoparticles by precipitation make it possible to obtain primary nanoparticles of homogeneous size with a reduced size distribution, of good crystallinity and purity. It is also possible to obtain with these methods very small particle sizes, potentially less than 10 nm, and in a non-aggregated state. For this, it is necessary to add a ligand directly into the synthesis reactor so as to prevent the formation of agglomerates, aggregates during synthesis. For example, PVP can be used to perform this function.

As the non-agglomerated nanoparticle size distribution obtained by precipitation is relatively narrow, it is necessary to prefer a colloidal suspension preparation strategy mixing two size distributions following the rules described above in order to maximise the compactness of the deposition before sintering. This will make it possible after sintering to produce relatively thick depositions, directly on metallic substrates with little or no risks of cracking during the sintering heat treatment which will be maintained at a relatively low temperature due to the small size of the nanoparticles used.

The bimodal nanoparticle suspension is then used to deposit the compact layers, which will then be densified by a low-temperature heat treatment and suitable for use particularly as electrodes or electrolyte in electrochemical devices such as for example lithium ion batteries. Various methods can be used for depositing these layers, particularly electrophoresis, ink-jet printing, doctor blade coating, roll coating, curtain coating, dip-coating, slot-die deposition. These methods are simple, safe, easy to implement, industrialise, and make it possible to obtain a homogeneous final dense layer.

Electrophoresis makes it possible to deposit a uniform layer on large surface areas with a high deposition speed. Coating techniques, particularly dip-coating, roll coating, curtain coating or doctor blade coating, make it possible to simplify the management of baths with respect to electrophoresis, as the composition of the bath remains constant during deposition by coating. Ink-jet printing deposition makes it possible to produce localised depositions.

Dense electrodes and electrolytes in a thick layer and produced in a single step can be obtained with the methods cited above using bimodal or polydisperse nanoparticle suspensions.

The method according to the invention makes it possible to manufacture dense layers having a density of at least 90% of the theoretical density, preferably at least 95% of the theoretical density, and even more preferably at least 96% of the theoretical density, and optimally at least 97% of the theoretical density, knowing that the remainder consists of a residual porosity, which consists of closed pores.

The embodiment of a dense electrode according to the invention is now described by way of non-limiting example; in this description, a more in-depth description of certain details of the method according to the invention is given.

### Nature of the Current Collector

As a general rule, the substrate serving as a current collector in the batteries using dense electrodes according to the invention is metallic, for example a metal sheet. It must be selected so as to withstand the temperature of any heat or thermomechanical treatment which will be applied on the layer deposited on this substrate, and this temperature will be dependent on the chemical nature of said layer. The substrate is preferably selected from strips made of titanium, molybdenum, chromium, tungsten, copper, nickel or stainless steel or any alloy containing at least one of the preceding elements.

As a general rule, the metal sheet can be coated with a layer of noble metal, particularly selected from gold, platinum, palladium, titanium, molybdenum, tungsten, chromium or alloys containing mostly at least one or more of these metals, or a layer of ITO type conductive material (which has the advantage of also acting as a diffusion barrier).

In this example, we will use a sheet of 316L type stainless steel of 10 microns in thickness.

### Deposition of a Dense Electrode Layer by Dip-Coating

As a general rule, this electrode layer can be deposited either on a metallic surface of the current collector, or on another dense or porous inorganic layer, for example on a dense electrolyte layer or on a porous separator.

It is possible to deposit bimodal nanoparticles with the dip-coating method, regardless of the chemical nature of the nanoparticles used; obviously, the other deposition techniques mentioned above can also be used. For example, to produce a dense ceramic deposition of Li₄Ti₅O₁₂, we can produce an ink composed of nanoparticles of two different sizes, in the case of anode made of Li₄Ti₅O₁₂, nanoparticles of Li₄Ti₅O₁₂ of about 5 nm are synthesised by the glycothermal route (see the article “Impact of the Synthesis Parameters on the microstructure of nano-structured LTO prepared by glycothermal routes and ⁷Li NMR structural investigations”, M. Odziomek, F. Chaput et al., published in J Sol-Gel Sci Technol 89, 225-233 (2019)). To this synthesis, ligands are added to limit nanoparticle agglomeration. These nanoparticles of 5 nm in diameter are associated with Li₄Ti₅O₁₂ nanoparticles obtained by hydrothermal synthesis with particle sizes of 30 nm.

These nanoparticles are mixed, dispersed by ultrasound, with 70% by mass of 30 nm particles and 30% by mass of 5 nm nanoparticles in an ink with 15% overall dry extract, in ethanol and containing PVP as a stabiliser. Each dip-coating pass only produces a layer of relatively limited thickness; the wet layer must be dried. In order to obtain a layer of a desired final thickness, the dip-coating deposition step followed by the step of drying the layer can be repeated as many times as required.

Although this succession of dip-coating/drying steps is time-consuming, the dip-coating deposition method is a method that is simple, safe, easy to implement, industrialise and making it possible to obtain a homogeneous and compact final layer.

### Treatment and Properties of the Deposited Layers

As a general rule, the layers deposited by dip-coating must be dried. Once dried, a heat treatment is performed in two phases. In a first phase, the deposition is maintained for 10 minutes at 400° C. in order to calcine all the organic compounds contained therein. Then the treatment temperature is increased to 550° C. and maintained for one hour at this temperature in order to obtain the consolidation of the deposition.

The selection of the materials of the nanoparticles is obviously dependent on the function of the layers thus deposited in the targeted electrochemical, electrical or electronic device. As a general rule, the nanoparticles used in the present invention are inorganic and non-metallic, knowing that they can be coated with an organic functionalisation layer (“core-shell” type particles); this will be described hereinafter. These particles coated with an organic layer are included here in the term “inorganic particles”.

If the layer according to the invention is to function as a cathode of a battery, particularly a lithium ion battery, it can be produced for example from a material P which a cathode material selected from:
the oxides LiMn₂O₄, Li₁₊ₓMn₂₋ₓO₄ where 0<x<0.15, LiCoO₂, LiNiO₂, LiMn_{1.5}Ni_{0.5}O₄, LiMn_{0.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ where M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ where 0≤x<0.15, LiNi_{1/x}Co_{1/y}Mn_{1/z}O₂ where x+y+z=10;
the phosphates LiFePO₄, LiMnPO₄, LiCoPO₄, LiNiPO₄, Li₃V₂(PO₄)₃; the phosphates of formula LiMM′PO₄, where M and M′ (M≠M′) are selected from Fe, Mn, Ni, Co, V;
all lithiated forms of the following chalcogenides: V₂O₅, V₃O₈, TiS₂, titanium oxysulphides (TiO_{y}S_{z} where z=2−y and 0.3≤y≤1), tungsten oxysulphides (WO_{y}S_{z} where 0.6<y<3 and 0.1<z<2), CuS, CuS₂, preferably LiₓV₂O₅ where 0<x≤2, LiₓV₃O₈ where 0<x≤1.7, LiₓTiS₂ where 0<x≤1, titanium and lithium oxysulphides LiₓTiO_{y}S_{z} where z=2−y, 0.3≤y≤1, LiₓWO_{y}S_{z}, LiₓCuS, LiₓCuS₂.

If the layer according to the invention is to function as an anode of a battery, particularly a lithium ion battery, it can be produced for example from a material P which an anode material selected from:
carbon nanotubes, graphene, graphite;
lithiated iron phosphate (of typical formula LiFePO₄);
mixed silicon and tin oxynitrides (of typical formula SiₐSn_{b}O_{y}Nz where a>0, b>0, a+b≤2, 0<y≤4, 0<z≤3) (also known as SiTON), and in particular SiSn_{0.87}O_{1.2}N_{1.72;} as well as oxynitrides-carbides of typical formula SiₐSn_{b}C_{c}O_{y}N_{z} where a>0, b>0, a+b≤2, 0<c<10, 0<y<24, 0<z<17;
nitrides of type SiₓN_{y} (in particular where x=3 and y=4), SnₓN_{y} (in particular where x=3 and y=4), ZnₓN_{y} (in particular where x=3 and y=2), Li₃₋ₓMₓN (where 0≤x≤0.5 for M=Co, 0≤x≤0.6 for M=Ni, 0≤x≤0.3 for M=Cu); Si₃₋ₓMₓN₄ where M=Co or Fe and 0≤x≤3;
the oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂;
composite oxides TiNb₂O₇ comprising between 0% and 10% by mass of carbon, preferably the carbon being selected from graphene and carbon nanotubes;
compounds of general formula Li_{w}Ti₁₋ₓM¹ₓNb_{2-y}M²_{y}O_{7-z}M³_{z} wherein M¹ and M² are each at least one elements selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, M¹ and M² optionally being identical or different from one another, and wherein M³ is at least one halogen, and wherein 0≤w≤5, 0≤x<1, 0≤y<2 and 0<z≤0.3.

If the layer according to the invention is to function as an electrolyte in a battery, particularly a lithium ion battery, it can be produced for example from a material P which is an electrolyte material selected from:
garnets of formula Li_{d}A¹ₓA²_{y}(TO₄)_{z} where A¹ represents a cation of degree of oxidation +II, preferably Ca, Mg, Sr, Ba, Fe, Mn, Zn, Y, Gd; and where A² represents a cation of degree of oxidation +III, preferably Al, Fe, Cr, Ga, Ti, La; and where (TO₄) represents an anion wherein T is an atom of degree of oxidation +IV, located at the centre of a tetrahedron formed by oxygen atoms, and wherein TO₄ represents advantageously the silicate or zirconate anion, knowing that all or part of the elements T of a degree of oxidation +IV can be replaced by atoms of a degree of oxidation +III or +V, such as Al, Fe, As, V, Nb, In, Ta; knowing that: d is between 2 and 10, preferably between 3 and 9, and even more preferably between 4 and 8; x is between 2.6 and 3.4 (preferably between 2.8 and 3.2); y is between 1.7 and 2.3 (preferably between 1.9 and 2.1) and z is between 2.9 and 3.1;
garnets, preferably selected from: Li₇La₃Zr₂O₁₂; Li₆La₂BaTa₂O₁₂; Li_{5.5}La₃Nb_{1.75}In_{0.25}O₁₂; Li₅La₃M₂O₁₂ where M=Nb or Ta or a mixture of these two compounds; Li₇₋ₓBaₓLa₃₋ₓM₂O₁₂ where 0≤x≤1 and M=Nb or Ta or a mixture of the two compounds; Li₇₋ₓLa₃Zr₂₋ₓMₓO₁₂ where 0≤x≤2 and M=Al, Ga or Ta or a mixture of two or three of these compounds;
lithiated phosphates, preferably selected from: lithiated phosphates of the type NaSICON, Li₃PO₄; LiPO₃; Li₃Al_{0.4}Sc_{1.6}(PO₄)₃ referred to as “LASP”; Li_{1.2}Zr_{1.9}Ca_{0.1}(PO₄)₃; LiZr₂(PO₄)₃; Li₁₊₃ₓZr₂(P₁₋ₓSiₓO₄)₃ where 1.8<x<2.3; Li₁₊₆ₓZr₂(P₁₋ₓBₓO₄)₃ where 0≤x≤0.25; Li₃(Sc₂₋ₓMₓ)(PO₄)₃ where M=Al or Y and 0≤x≤1; Li₁₊ₓMₓ(Sc)₂₋ₓ(PO₄)₃ where M=Al, Y, Ga or a mixture of the three compounds and 0≤x≤0.8; Li₁₊ₓMₓ(Ga_{1-y}Sc_{y})₂₋ₓ(PO₄)₃ where 0≤x≤0.8; 0≤y≤1 and M=Al or Y or a mixture of both compounds; Li₁₊ₓMₓ(Ga)₂₋ₓ(PO₄)₃ where M=Al, Y or a mixture of both compounds and 0≤x≤0.8; Li₁₊ₓAlₓTi₂₋ₓ(PO₄)₃ where 0≤x≤1 referred to as “LATP”; or Li₁₊ₓAlₓGe₂₋ₓ(PO₄)₃ where 0≤x≤1 referred to as “LAGP”; or Li_{1+x+z}Mₓ(Ge_{1-y}Ti_{y})₂₋ₓSi_{z}P_{3-z}O₁₂ where 0≤x≤0.8 and 0≤y≤1.0 and 0≤z≤0.6 and M=Al, Ga or Y or a mixture of two or three of these compounds; Li_{3+y}(Sc₂₋ₓMₓ)Q_{y}P_{3-y}O₁₂ where M=Al and/or Y and Q=Si and/or Se, 0≤x≤0.8 and 0≤y≤1; or Li_{1+x+y}MₓSc₂₋ₓQ_{y}P_{3-y}O₁₂ where M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ where 0≤x≤0.8, 0≤y≤1, 0≤z≤0.6 where M=Al or Y or a mixture of both compounds and Q=Si and/or Se; or Li₁₊ₓZr₂₋ₓBₓ(PO₄)₃ where 0≤x≤0.25; or Li₁₊ₓZr₂₋ₓCaₓ(PO₄)₃ where 0≤x≤0.25; or Li₁₊ₓM³ₓM₂₋ₓP₃O₁₂ where 0≤x≤1 and M³=Cr, V, Ca, B, Mg, Bi and/or Mo, M=Sc, Sn, Zr, Hf, Se or Si, or a mixture of these compounds; or Li₁₊₂ₓCaₓZr₂₋ₓ(PO₄)₃ where 0≤x≤0.25;
lithiated borates, preferably selected from: Li₃(Sc₂₋ₓMₓ)(BO₃)₃ where M=Al or Y and 0≤x≤1; Li₁₊ₓMₓ(Sc)₂₋ₓ(BO₃)₃ where M=Al, Y, Ga or a mixture of the three compounds and 0≤x≤0.8; Li₁₊ₓMₓ(Ga_{1-y}Sc_{y})₂₋ₓ(BO₃)₃ where 0≤x≤0.8, 0≤y≤1 and M=Al or Y; Li₁₊ₓMₓ(Ga)₂₋ₓ(BO₃)₃ where M=Al, Y or a mixture of both compounds and 0≤x≤0.8; Li₃BO₃, Li₃BO₃—Li₂SO₄, Li₃BO₃—Li₂SiO₄, Li₃BO₃—Li₂SiO₄—Li₂SO₄;
oxynitrides, preferably selected from Li₃PO₄₋ₓN_{2x/3}, Li₄SiO₄₋ₓN_{2x/3}, Li₄GeO₄₋ₓN_{2x/3} where 0<x<4 or Li₃BO₃₋ₓN_{2x/3} where 0<x<3;
lithiated compounds based on lithium and phosphorus oxynitride, referred to as “LiPON”, in the form of LiₓPO_{y}N_{z} where x˜2.8 and 2y+3z˜7.8 and 0.16≤z≤0.4, and in particular Li_{2.9}PO_{3.3}N_{0.46,} but also the compounds Li_{w}POₓN_{y}S_{z} where 2x+3y+2z=5=w or the compounds Li_{w}POₓN_{y}S_{z} where 3.2≤x≤3.8, 0.13≤y≤0.4, 0≤z≤0.2, 2.9≤w≤3.3 or the compounds in the form of LiₜPₓAl_{y}OᵤNᵥS_{w} where 5x+3y=5, 2u+3v+2w=5+t, 2.9≤t≤3.3, 0.84≤x≤0.94, 0.094≤y≤0.26, 0.13≤v≤0.46, 0≤w≤0.2;
materials based on lithium phosphorus or boron oxynitrides, referred to respectively as “LiPON” and LIBON”, optionally also containing silicon, sulphur, zirconium, aluminium, or a combination of aluminium, boron, sulphur and/or silicon, and boron for materials based on lithium phosphorus oxynitrides;
lithiated compounds based on lithium, phosphorus and silicon oxynitride referred to as “LiSiPON”, and in particular Li_{1.9}Si_{0.28}P_{1.0}O_{1.1}N_{1.0};
lithium oxynitrides of the types LiBON, LiBSO, LiSiPON, LiSON, thio-LiSiCON, LiPONB (where B, P and S represent respectively boron, phosphorus and sulphur);
lithium oxynitrides of the type LiBSO such as (1−x)LiBO₂₋ₓLi₂SO₄ where 0.4≤x≤0.8;
lithiated oxides, preferably selected from Li₇La₃Zr₂O₁₂ or Li₅₊ₓLa₃(Zrₓ,A₂₋ₓ)O₁₂ where A=Sc, Y, Al, Ga and 1.4≤x≤2 or Li_{0.35}La_{0.55}TiO₃ or Li₃ₓLa_{2/3-x}TiO₃ where 0≤x≤0.16 (LLTO);
silicates, preferably selected from Li₂Si₂O₅, Li₂SiO₃, Li₂Si₂O₆, LiAlSiO₄, Li₄SiO₄, LiAlSi₂O₆;
anti-perovskite type solid electrolytes selected from: Li₃OA where A is a halide or halide mixture, preferably at least one of the elements selected from F, Cl, Br, I or a mixture of two or three or four of these elements; Li₍₃₋ₓ₎M_{x/2}OA where 0<x≤3, M a is divalent metal, preferably at least one of the elements selected from Mg, Ca, Ba, Sr or a mixture of two or three or four of these elements, A is a halide or halide mixture, preferably at least one of the elements selected from F, Cl, Br, I or a mixture of two or three or four of these elements; Li₍₃₋ₓ₎M³_{x/3}OA where 0≤x≤3, M³ is a trivalent metal, A is a halide or a halide mixture, preferably at least one of the elements selected from F, Cl, Br, I or a mixture of two or three or four of these elements; or LiCOX_{z}Y_{(1-z)}, where X and Y are halides as mentioned above in relation to A, and 0≤z≤1,
the compounds La_{0.51}Li_{0.34}Ti_{2.94}, Li_{3.4}V_{0.4}Ge_{0.6}O₄, Li₂O—Nb₂O₅, LiAlGaSPO₄;
formulations based on Li₂CO₃, B₂O₃, Li₂O, Al(PO₃)₃LiF, P₂S₃, Li₂S, Li₃N, Li₁₄Zn(GeO₄)₄, Li_{3.6}Ge_{0.6}V_{0.4}O₄, LiTi₂(PO₄)₃, Li_{3.25}Ge_{0.25}P_{0.25}S₄, Li_{1.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂ (where 0≤x≤1 and 0≤y≤1).

### Use of Coated Nanoparticles (“Core-Shell” Type)

As a general rule, the nanoparticles used in inks serving to make these depositions intended for electrodes can also have a core-shell structure. Indeed, the performance of the dense electrodes thus obtained will be dependent on the ionic and electronic conduction property thereof. In addition, on the surface of the nanoparticles of active material, it can be important to apply a “shell” of an inorganic material, endowed with good electronic and/or ionic conduction properties.

Thus, in an advantageous embodiment, the core is formed of an electrode material (anode or cathode), and the shell is formed of a material which is both electronically conductive and which does not prevent the passage of lithium ions. By way of example, the shell can be formed by a layer of a metal, which is thin enough to allow lithium ions to pass, or by a layer of graphite thin enough or by a layer of an ionic conductor which is also a good electronic conductor.

The core-shell approach can also be applied to the manufacture of the electrolyte. Thus, in a further embodiment, the core of the nanoparticles used in the method according to the invention is formed of an electrolyte material, and the shell is formed of an inorganic or organic material which is a good ion conductor, particularly of lithium ions, and which should a good electronic insulator.

When the shell layer is an organic layer, it is preferred that this layer be made of polymer material. A layer of polymer has, inter alia, the advantage of being malleable, which facilitates the compaction of the layer deposited using these particles.

We now describe a method for preparing inorganic nanoparticles having a polymer shell. It is particularly suitable for the nanoparticles of electrolyte material, for which the shell should be an electrical insulator and an ionic conductor. This method, referred to here as “functionalisation” of the inorganic nanoparticles forming the core by a shell, consists of grafting on the surface of the nanoparticles a molecule having a Q-Z type structure wherein Q is a function bonding the molecule to the surface, and Z is preferably a PEO group.

By way of Q group, a complexing function of the surface cations of the nanoparticles can be used such as the phosphate or phosphonate function.

Preferably, the inorganic nanoparticles are functionalised by a PEO derivative of the type:

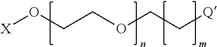

where X represents an alkyl chain or a hydrogen atom, n is between 40 and 10,000 (preferably between 50 and 200), m is between 0 and 10, and Q′ is an embodiment of Q and represents a group selected in the group formed by:

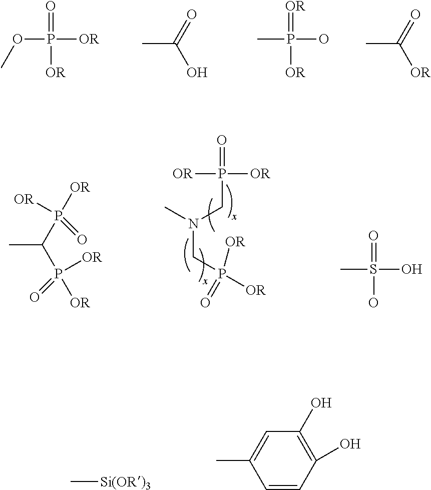

and where R represents an alkyl chain or a hydrogen atom, R′ represents a methyl group or an ethyl group, x is between 1 and 5, and x′ is between 1 and 5.

More preferably, the inorganic nanoparticles are functionalised by methoxy-PEO-phosphonate:

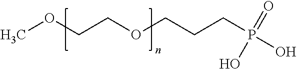

where n is between 40 and 10,000 and preferably between 50 and 200.

According to an advantageous embodiment, a solution of Q-Z (or Q′-Z, where applicable) is added to a colloidal suspension of electrolyte nanoparticles of electrolyte or of electronic insulator so as to obtain a molar ratio between Q (which comprises here Q′) and the set of cations present in the inorganic nanoparticles (abbreviated here as “NP-C”) between 1 and 0.01, preferably between 0.1 and 0.02. Beyond a molar ratio Q/NP-C of 1, the functionalisation of the electronic inorganic nanoparticles by the molecule Q-Z is liable to induce a steric size such that said nanoparticles cannot be completely functionalised; this is also dependent on the size of the nanoparticles. For a molar ratio Q/NP-C less than 0.01, the molecule Q-Z is liable not to be of a sufficient quantity to provide sufficient conductivity of lithium ions; this is also dependent on the particle size. The use of a greater quantity of Q-Z during functionalisation would result in an unnecessary consumption of Q-Z.

A colloidal suspension of inorganic nanoparticles at a mass concentration between 0.1% and 50%, preferably between 5% and 25%, and even more preferably at 10% is used to carry out the functionalisation of the inorganic nanoparticles. At high concentrations, there can be a risk of bridging and a lack of accessibility of the surface to be functionalised (risk of precipitation or poorly or non-functionalised particles). Preferably, the inorganic nanoparticles are dispersed in a liquid phase such as water or ethanol.

This reaction can be carried out in any suitable solvents capable of solubilising the molecule Q-Z.

According to the molecule Q-Z, the functionalisation conditions can be optimised by adjusting the temperature and duration of the reaction, and the solvent used. After having added a solution of Q-Z to a colloidal suspension of electrolyte nanoparticles, the reaction medium is left under stirring for 0 h to 24 hours (preferably for 5 minutes to 12 hours, and even more preferably for 0.5 hours to 2 hours), such that at least a portion, preferably all of the molecules Q-Z can be grafted on the surface of the inorganic nanoparticles. The functionalisation can be carried out with heating, preferably at a temperature between 20° C. and 100° C. The temperature of the reaction medium must be adapted to the choice of the functionalising molecule Q-Z.

These functionalised nanoparticles therefore have a core or inorganic material and a shell of PEO. The thickness of the shell can be typically between 1 nm and 100 nm; this thickness can be determined by transmission electron microscopy after labelling the polymer with ruthenium oxide (RuO₄).

Advantageously, the nanoparticles thus functionalised are then purified with successive centrifugation cycles and redispersions and/or by tangential filtration.

After redispersing the functionalised inorganic nanoparticles, the suspension can be reconcentrated until the sought dry extract is attained, by any suitable means.

Advantageously, the dry extract of a suspension of inorganic nanoparticles functionalised with PEO comprises more than 40% (by volume) of solid electrolyte material, preferably more than 60% and even more preferably more than 70% of solid electrolyte material.

The densification of the layer produced with organic core-shell type nanoparticles after the deposition thereof can be carried out by suitable means, preferably:

a) by any mechanical means, in particular by mechanical compression, preferably uniaxial compression;

b) by thermocompression, i.e. by heat treatment under pressure. The optimal temperature is closely dependent on the chemical composition of the materials deposited, it is also dependent on the particle sizes and the compactness of the layer. A controlled atmosphere is preferably maintained in order to prevent oxidation and surface pollution of the particles deposited.

Advantageously, the compaction is carried out in a controlled atmosphere and at temperatures between ambient temperature and the melting point of the polymer (typically the PEO) used; the thermocompression can be performed at a temperature between ambient temperature (about 20° C.) and about 300° C.; but it is preferred not to exceed 200° C. (or even more preferably 100° C.) in order to prevent PEO degradation.

As stated above, one of the advantages of organic shells is the malleability of the shell; PEO is for example a readily deformable polymer at a relatively low pressure. Thus, the densification of the nanoparticles of electrolyte or of electronic insulator functionalised by a polymer such as PEO can be obtained solely by mechanical compression (application of a mechanical pressure). Advantageously, the compression is performed in a pressure range between 10 MPa and 500 MPa, preferably between 50 MPa and 200 MPa and at a temperature of the order of 20° C. to 200° C.

At the interfaces, PEO is amorphous and ensures good ionic contact between the solid electrolyte particles. PEO can thus conduct lithium ions, even in the absence of liquid electrolyte; PEO is at the same time an electronic insulator. It favours the assembly of the lithium ion battery at low temperatures, thus limiting the risk of interdiffusion at the interfaces between the electrolytes and the electrodes.

In a lithium ion battery, the electrolyte layer obtained after densification can have a thickness less than 10 μm, preferably less than 6 μm, preferably less than 5 μm, in order to limit the thickness and the weight of the battery without diminishing the properties thereof.

Use of the Method According to the Invention for Depositing Layers in Batteries which also Comprise Mesoporous Layers

The method according to the invention makes it possible to deposit inorganic dense layers in lithium ion batteries with a capacitance greater than 1 mA h. In these devices, said dense layers can perform the function of an anode or a cathode or an electrode, and the battery can include several inorganic dense layers according to the invention. These batteries can be of “all-solid-state” type, the dense layers only having a very low porosity. According to a variant of the invention, the battery also includes at least one porous inorganic layer.

According to this variant of the invention, the “porous inorganic layer”, preferably mesoporous, can be deposited with a method selected preferably in the group formed by: electrophoresis, a printing method, selected preferably from ink-jet printing and flexographic printing, and a coating method selected preferably from roll coating, curtain coating, doctor blade coating, slot-die coating, dip-coating, using a suspension of nanoparticle aggregates or agglomerates, preferably using a concentrated suspension containing nanoparticle agglomerates.

More specifically, a colloidal suspension is used comprising aggregates or agglomerates of nanoparticles of at least one inorganic material, of mean primary diameter D₅₀ between 2 nm and 100 nm, preferably between 2 nm and 60 nm, said aggregates or agglomerates typically having a mean diameter D₅₀ between 50 nm and 300 nm (preferably between 100 nm and 200 nm). Then the layer thus obtained is dried and the layer is consolidated, by pressing and/or heating, to obtain a porous layer, preferably mesoporous and inorganic. This method is particularly advantageous with nanoparticles formed of electrolyte materials.

The mesoporous layer can be deposited on a dense layer deposited with the method according to the invention, or said dense layer is deposited on said mesoporous layer prepared with the method described above.

So that said porous layer can fulfil the electrolyte function thereof, it must be impregnated with a mobile cation carrier liquid; in the case of a lithium ion battery, this cation is a lithium cation. This lithium ion carrier phase is preferably selected in the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer rendered an ionic conductor by adding at least one lithium salt; and
a polymer rendered an ionic conductor by adding a liquid electrolyte, either in the polymer phase, or in the mesoporous structure,
said polymer being preferably selected in the group formed by poly(ethylene oxide), poly(propylene oxide), polydimethylsiloxane, polyacrylonitrile, poly(methyl methacrylate), poly(vinyl chloride), poly(vinylidene fluoride), PVDF-hexafluoropropylene.

### Example of Manufacture of a Lithium Ion Battery

A method for manufacturing lithium ion batteries using layers according to the invention is described here.

### a) Preparation of the Electrodes with the Deposition Method According to the Invention

A first dense Li₄Ti₅O₁₂ electrode obtained with the method described above in the section “Deposition of a dense electrode layer by dip-coating” was deposited. A second dense LiMn₂O₄ electrode was also deposited with a similar method. On each of these two electrodes, a thin mesoporous film of Li₃PO₄ agglomerates, acting as a separating film in the battery, and which was prepared as described hereinafter, was then deposited.

### b) Deposition of the Separating Layer

A suspension of Li₃PO₄ nanoparticles was prepared using the two solutions described hereinafter: Firstly, 45.76 g of CH₃COOLi, 2H₂O was dissolved in 448 ml of water, then 224 ml of ethanol was added under vigorous stirring to the medium in order to obtain a solution A. Secondly, 16.24 g of H₃PO₄ (85 wt % in water) was diluted in 422.4 ml of water, then 182.4 ml of ethanol was added to this solution in order to obtain a second solution hereinafter referred to as solution B. Solution B was then added, under vigorous stirring, to solution A.

The solution obtained, perfectly clear after the bubbles formed during mixing disappeared, was added to 4.8 litres of acetone under the action of an Ultraturrax™ type homogeniser in order to homogenise the medium. A white precipitation suspended in the liquid phase was immediately observed.

The reaction medium was homogenised for 5 minutes then was kept for 10 minutes under magnetic stirring. The whole was allowed to settle for 1 to 2 hours. The supernatant was removed then the remaining suspension was centrifuged for 10 minutes at 6000 g. Then, 1.2 l of water was added to resuspend the precipitate (use of a sonotrode, magnetic stirring). Two additional washes of this type were then performed with ethanol. Under vigorous stirring, 15 ml of a 1 g/ml Bis(2-(methacryloyoloxy)ethyl)phosphate was added to the colloidal suspension in ethanol thus obtained. The suspension thus became more stable. The suspension was then sonicated using a sonotrode. The suspension was then centrifuged for 10 minutes at 6000 g. The pellet was then redispersed in 1.2 l of ethanol then centrifuged for 10 minutes at 6000 g. The pellets thus obtained are redispersed in 900 ml of ethanol in order to obtain a 15 g/l suspension capable of carrying out an electrophoretic deposition.

Agglomerates of about 200 nm consisting of 10 nm primary Li₃PO₄ particles were thus obtained suspended in ethanol. Porous thin layers of Li₃PO₄ were then deposited by electrophoresis on the surface of the anodes and cathodes previously prepared by applying an electric field of 20 V/cm to the Li₃PO₄ nanoparticle suspension previously obtained, for 90 seconds to obtain a layer of about 2 μm. The layer was then air-dried at 120° C. then a calcination treatment at 350° C. for 120 minutes was performed on this previously dried layer in order to remove any trace of organic residue.

### c) Assembly of the Electrodes and the Separator

After having deposited 2 μm of porous Li₃PO₄ on each of the electrodes (Li₁₊ₓMn_{2-y}O₄ and Li₄Ti₅O₁₂) previously prepared, both subsystems were stacked in such a way that the Li₃PO₄ films are in contact. This stack was then hot-pressed in a vacuum between two planar plates. To do this, the stack was first placed at a pressure of 5 MPa then vacuum-dried for 30 minutes at 10⁻³ bar. The plates of the press were then heated at 550° C. with a rate of 0.4° C./second. At 550° C., the stack was then thermo-compressed at a pressure of 45 MPa for 20 minutes, then the system was cooled to ambient temperature. Then, the assembly was dried at 120° C. for 48 hours in a vacuum (10 mbar).

### d) Impregnation of the Separator by a Liquid Electrolyte

This assembly was then impregnated, in an anhydrous atmosphere, by dipping in an electrolytic solution comprising PYR14TFSI, and 0.7 M LiTFSI. PYR14TFSI is the standard abbreviation of 1-butyl-1-methylpyrrolidinium bis(trifluoro-methanesulfonyl)imide. LITFSI is the standard abbreviation of lithium bis-trifluoromethanesulfonimide (CAS No.: 90076-65-6). This ionic liquid enters instantaneously by capillarity in the porosities of the separator. Each of the two ends of the system was kept immersed for 5 minutes in a drop of the electrolytic mixture. It is noted that in an industrial manufacturing method, the impregnation is performed after encapsulating the battery, and followed by the production of the electrical contact members.

As a general rule, the battery according to the invention can be a mini-battery, the capacitance of which is greater than 1 mA h and up to about 1 A h, or a battery the capacitance of which is greater than 1 A h. Indeed, the method according to the invention lends itself particularly well to producing layers with a thickness greater than 1 μm, even greater than 5 μm, while still providing a low serial resistance of the battery.

These batteries and mini-batteries can be produced:
either solely with layers of “all-solid-state” type, i.e. devoid of impregnated liquid or pasty phases (said liquid or pasty phases optionally being a lithium ion conducting medium, capable of acting as an electrolyte), or
with electrodes according to the invention and mesoporous “all-solid-state” type separators, impregnated with a liquid or pasty phase, typically a lithium ion conducting medium, which spontaneously enters the inside of the layer and which no longer comes out of this layer, such that this layer can be considered as quasi-solid, or
with an electrode according to the invention and impregnated porous separators (i.e. layers having a lattice of open pores which can be impregnated with a liquid or pasty phase, and which gives these layers wet properties).

### Different Aspects of the Invention

As is clear from the description given, the present invention has several aspects, features and combinations of features which are compiled in a summarised manner hereinafter.

A first aspect of the invention is a method for manufacturing a dense layer, which comprises the steps of:
supplying a substrate and a suspension of non-agglomerated nanoparticles of an inorganic material P,
depositing a layer, on said substrate, using the suspension of primary nanoparticles of a material P;
drying the layer thus obtained;
densifying the dried layer by mechanical compression and/or heat treatment, knowing that the third and the fourth step can be performed at least partially at the same time, or during a temperature ramp, said method being characterised in that said suspension of non-agglomerated nanoparticles of material P comprises nanoparticles of material P having a size distribution, said size being characterised by the value of D₅₀ thereof, such that the distribution comprises nanoparticles of material P of a first size D1 between 20 nm and 50 nm, and nanoparticles of material P of a second size D2 characterised by a value D50 at least five times less than that of D1.

According to an alternative, the distribution has a mean size of nanoparticles of material P less than 50 nm, and a standard deviation to mean size ratio greater than 0.6.

According to a first variant of this first aspect, said suspension of non-agglomerated nanoparticles of material P comprises nanoparticles of material P of a first size D1 between 20 nm and 50 nm, and nanoparticles of material P of a second size D2 characterised by a value D₅₀ at least five times less than that of D1, and said particles of size D1 represent between 50 and 75% of the total mass of nanoparticles. Preferably, the mean diameter of the second population is at least one fifteenth of the first nanoparticle population, and preferably at least one twelfth.

According to a second variant of this first aspect, which is also compatible with the first variant thereof, said suspension of non-agglomerated nanoparticles of material P is obtained using a monodisperse suspension of nanoparticles of size D1.

According to a third variant of this first aspect, which is also compatible with the first and second variant thereof, the suspension of nanoparticles of size D2 is obtained using a monodisperse suspension.

According to a fourth variant of this first aspect, which is also compatible with the first, second and third variant thereof, a mixture of two nanoparticle size populations is used, such that the mean diameter of the greatest distribution does not exceed 100 nm, and preferably does not exceed 50 nm. Preferably, this first population of the largest nanoparticles has a size distribution characterised by a sigma/Rₘₑₐₙ ratio less than 0.6.

In a first sub-variant of this variant, preferably, said population of the largest nanoparticles represents between 50% and 75% of the dry extract of the deposition, and the second nanoparticle population represents between 50% and 25% of the dry extract of the deposition (these percentages being expressed as a mass percentage with respect to the total mass of nanoparticles in the deposition).

In a second sub-variant of this fourth variant, the mean diameter of the particles of this second population is at least 5 times smaller than that of the first nanoparticle population, and preferably the mean diameter of the second population is at least one fifteenth of that of the first population of nanoparticles, and preferably at least one twelfth. Preferably, this second population has a size distribution characterised by a sigma/Rmean ratio less than 0.6.

According to a fifth variant of this first aspect, which is also compatible with the first, second, third and fourth variant thereof, for the deposition of said dense layer, a method selected from printing techniques, particularly ink-jet and flexographic printing, electrophoresis techniques, and coating techniques, particularly roll, curtain, doctor blade, dip, or slot-die coating, is used.

According to a sixth variant of this first aspect, which is also compatible with the first, second, third, fourth and fifth variant thereof, said suspension has a viscosity, measured at 20° C., between 20 cP and 2000 cP.

According to a seventh variant of this first aspect, which is also compatible with the first, second, third, fourth, fifth and sixth variant thereof, said material P is an inorganic material, preferably selected in the group formed by:
cathode materials, preferably selected in the group formed by:
the oxides LiMn₂O₄, Li₁₊ₓMn₂₋ₓO₄ where 0<x<0.15, LiCoO₂, LiNiO₂, LiMn_{1.5}Ni_{0.5}O₄, LiMn_{0.5}; Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ where M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ where 0≤x<0.15, LiNi_{1/x}Co_{1/y}Mn_{1/z}O₂ where x+y+z=10;
the phosphates LiFePO₄, LiMnPO₄, LiCoPO₄, LiNiPO₄, Li₃V₂(PO₄)₃; the phosphates of formula LiMM′PO₄, where M and M′ (M≠M′) are selected from Fe, Mn, Ni, Co, V;
all lithiated forms of the following chalcogenides: V₂O₅, V₃O₈, TiS₂, titanium oxysulphides (TiO_{y}S_{z} where z=2−y and 0.3≤y≤1), tungsten oxysulphides (WO_{y}S_{z} where 0.6<y<3 and 0.1<z<2), CuS, CuS_{2,} preferably LiₓV₂O₅ where 0<x≤2, LiₓV₃O₈ where 0<x≤1.7, LiₓTiS₂ where 0<x≤1, titanium and lithium oxysulphides LiₓTiO_{y}S_{z} where z=2−y, 0.3≤y≤1, LiₓWO_{y}S_{z}, LiₓCuS, LiₓCuS₂;
anode materials, preferably selected in the group formed by:
carbon nanotubes, graphene, graphite,
lithiated iron phosphate (of typical formula LiFePO₄),
mixed silicon and tin oxynitrides (of typical formula SiₐSn_{b}O_{y}N_{z} where a>0, b>0, a+b≤2, 0<y≤4, 0<z≤3) (also known as SiTON), and in particular SiSn_{0.87}O_{1.2}N_{1.72;} as well as oxynitrides-carbides of typical formula SiₐSn_{b}C_{c}O_{y}N_{z} where a>0, b>0, a+b≤2, 0<c<10, 0<y<24, 0<z<17, and
nitrides of type SiₓN_{y} (in particular where x=3 and y=4), SnₓN_{y} (in particular where x=3 and y=4), ZnₓN_{y} (in particular where x=3 and y=2), Li₃₋ₓMₓN (where 0≤x≤0.5 for M=Co, 0≤x≤0.6 for M=Ni, 0≤x≤0.3 for M=Cu); Si₃₋ₓMₓN₄ where M=Co or Fe and 0≤x≤3;
the oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂;
composite oxides TiNb₂O₇ comprising between 0% and 10% by mass of carbon, preferably the carbon being selected from graphene and carbon nanotubes;
electrolyte materials, preferably selected in the group formed by:
garnets of formula Li_{d}A¹ₓA²_{y}(TO₄)_{z} where A¹ represents a cation of degree of oxidation +II, preferably Ca, Mg, Sr, Ba, Fe, Mn, Zn, Y, Gd, where A² represents a cation of degree of oxidation +III, preferably Al, Fe, Cr, Ga, Ti, La; and where (TO₄) represents an anion wherein T is an atom of degree of oxidation +IV, located at the centre of a tetrahedron formed by oxygen atoms, and where TO₄ represents advantageously the silicate or zirconate anion, knowing that all or part of the elements T of a degree of oxidation +IV can be replaced by atoms of a degree of oxidation +III or +V, such as Al, Fe, As, V, Nb, In, Ta; knowing that: d is between 2 and 10, preferably between 3 and 9, and even more preferably between 4 and 8; x is between 2.6 and 3.4 (preferably between 2.8 and 3.2); and y is between 1.7 and 2.3 (preferably between 1.9 and 2.1) and z is between 2.9 and 3.1;
garnets, preferably selected from: Li₇La₃Zr₂O₁₂; Li₆La₂BaTa₂O₁₂; Li_{5.5}La₃Nb_{1.75}In_{0.25}O₁₂; Li₅La₃M₂O₁₂ where M=Nb or Ta or a mixture of these two compounds; Li₇₋ₓBaₓLa₃₋ₓM₂O₁₂ where 0≤x≤1 and M=Nb or Ta or a mixture of the two compounds; Li₇₋ₓLa₃Zr₂₋ₓMₓO₁₂ where 0≤x≤2 and M=Al, Ga or Ta or a mixture of two or three of these compounds;
lithiated phosphates, preferably selected from: lithiated phosphates of the type NaSICON, Li₃PO₄; LiPO₃; Li₃Al_{0.4}Sc_{1.6}(PO₄)₃ referred to as “LASP”; Li_{1.2}Zr_{1.9}Ca_{0.1}(PO₄)₃; LiZr₂(PO₄)₃; Li₁₊₃ₓZr₂(P₁₋ₓSiₓO₄)₃ where 1.8<x<2.3; Li₁₊₆ₓZr₂(P₁₋ₓBₓO₄)₃ where 0≤x≤0.25; Li₃(Sc₂₋ₓMₓ)(PO₄)₃ where M=Al or Y and 0≤x≤1; Li₁₊ₓMₓ(Sc)₂₋ₓ(PO₄)₃ where M=Al, Y, Ga or a mixture of the three compounds and 0≤x≤0.8; Li₁₊ₓMₓ(Ga_{1-y}Sc_{y})₂₋ₓ(PO₄)₃ where 0≤x≤0.8; 0≤y≤1 and M=Al or Y or a mixture of both compounds; Li₁₊ₓMₓ(Ga)₂₋ₓ(PO₄)₃ where M=Al, Y or a mixture of both compounds and 0≤x≤0.8; Li₁₊ₓAlₓTi₂₋ₓ(PO₄)₃ where 0≤x≤1 referred to as “LATP”; or Li₁₊ₓAlₓGe₂₋ₓ(PO₄)₃ where 0≤x≤1 referred to as “LAGP”; or Li_{1+x+z}Mₓ(Ge_{1-y}Ti_{y})₂₋ₓSi_{z}P_{3-z}O₁₂ where 0≤x≤0.8 and 0≤y≤1.0 and 0≤z≤0.6 and M=Al, Ga or Y or a mixture of two or three of these compounds; Li_{3+y}(Sc₂₋ₓMₓ)Q_{y}P_{3-y}O₁₂ where M=Al and/or Y and Q=Si and/or Se, 0≤x≤0.8 and 0≤y≤1; or Li_{1+x+y}MₓSc₂—xQ_{y}P_{3-y}O₁₂ where M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ where 0≤x≤0.8, 0≤y≤1, 0≤z≤0.6 where M=Al or Y or a mixture of both compounds and Q=Si and/or Se; or Li₁₊ₓZr₂₋ₓBₓ(PO₄)₃ where 0≤x≤0.25; or Li₁₊ₓZr₂₋ₓCaₓ(PO₄)₃ where 0≤x≤0.25; or Li₁₊ₓM³ₓM₂₋ₓP₃O₁₂ where 0≤x≤1 and M³=Cr, V, Ca, B, Mg, Bi and/or Mo, M=Sc, Sn, Zr, Hf, Se or Si, or a mixture of these compounds; Li₁₊₂ₓCaₓZr₂₋ₓ(PO₄)₃ where 0≤x≤0.25;
lithiated borates, preferably selected from: Li₃(Sc₂₋ₓMₓ)(BO₃)₃ where M=Al or Y and 0≤x≤1; Li₁₊ₓMₓ(Sc)₂₋ₓ(BO₃)₃ where M=Al, Y, Ga or a mixture of the three compounds and 0≤x≤0.8; Li₁₊ₓMₓ(Ga_{1-y}Sc_{y})₂₋ₓ(BO₃)₃ where 0≤x≤0.8, 0≤y≤1 and M=Al or Y; Li₁₊ₓMₓ(Ga)₂₋ₓ(BO₃)₃ where M=Al, Y or a mixture of both compounds and 0≤x≤0.8; Li₃BO₃, Li₃BO₃—Li₂SO₄, Li₃BO₃—Li₂SiO₄, Li₃BO₃—Li₂SiO₄—Li₂SO₄;
oxynitrides, preferably selected from Li₃PO₄₋ₓN_{2x/3}, Li₄SiO₄ₓN_{2x/3}, Li₄GeO₄₋ₓN_{2x/3} where 0<x<4 or Li₃BO₃₋ₓN_{2x/3} where 0<x<3;
lithiated compounds based on lithium and phosphorus oxynitride, referred to as “LiPON”, in the form of LiₓPO_{y}N_{z} where x˜2.8 and 2y+3z˜7.8 and 0.16≤z≤0.4, and in particular Li_{2.9}PO_{3.3}N_{0.46,} but also the compounds Li_{w}PDₓN_{y}S_{z} where 2x+3y+2z=5=w or the compounds Li_{w}POₓN_{y}S_{z} where 3.2≤x≤3.8, 0.13≤y≤0.4, 0≤z≤0.2, 2.9≤w≤3.3 or the compounds in the form of LiₜPₓAl_{y}OᵤNᵥS_{w} where 5x+3y=5, 2u+3v+2w=5+t, 0.84≤x≤0.94, 0.094≤y≤0.26, 3.2≤u≤3.8, 0.13≤v≤0.46, 0≤w≤0.2;
materials based on lithium phosphorus or boron oxynitrides, referred to respectively as “LiPON” and LIBON”, optionally also containing silicon, sulphur, zirconium, aluminium, or a combination of aluminium, boron, sulphur and/or silicon, and boron for materials based on lithium phosphorus oxynitrides;
lithiated compounds based on lithium, phosphorus and silicon oxynitride referred to as “LiSiPON”, and in particular Li_{1.9}Si_{0.28}P_{1.0}O_{1.1}N_{1.0};
lithium oxynitrides of the types LiBON, LiBSO, LiSiPON, LiSON, thio-LiSiCON, LiPONB (where B, P and S represent respectively boron, phosphorus and sulphur);
lithium oxynitrides of the type LiBSO such as (1−x)LiBO₂−xLi₂SO₄ where 0.4≤x≤0.8;
lithiated oxides, preferably selected from Li₇La₃Zr₂O₁₂ or Li₅₊ₓLa₃(Zrₓ,A₂₋ₓ)O₁₂ where A=Sc, Y, Al, Ga and 1.4≤x≤2 or Li_{0.35}La_{0.55}TiO₃ or Li₃ₓLa_{2/3-x}TiO₃ where 0≤x≤0.16 (LLTO);
silicates, preferably selected from Li₂Si₂O₅, Li₂SiO₃, Li₂Si₂O₆, LiAlSiO₄, Li₄SiO₄, LiAlSi₂O₆;
anti-perovskite type solid electrolytes selected from: Li₃OA where A is a halide or halide mixture, preferably at least one of the elements selected from F, CI, Br, I or a mixture of two or three or four of these elements; Li(3-x)Mx/20A where 0 <x 3, M a is divalent metal, preferably at least one of the elements selected from Mg, Ca, Ba, Sr or a mixture of two or three or four of these elements, A is a halide or halide mixture, preferably at least one of the elements selected from F, Cl, Br, I or a mixture of two or three or four of these elements; Li₍₃₋ₓ₎M³_{x/3}OA where 0≤x≤3, M³ is a trivalent metal, A is a halide or a halide mixture, preferably at least one of the elements selected from F, Cl, Br, I or a mixture of two or three or four of these elements; or LiCOX_{z}Y_{(1-z)}, where X and Y are halides as mentioned above in relation to A, and 0≤z≤1;
the compounds La_{0.51}Li_{0.34}Ti_{2.94,} Li_{3.4}V_{0.4}Ge_{0.6}O₄, Li₂O—Nb₂O₅, LiAlGaSPO₄;

formulations based on Li₂CO₃, B₂O₃, Li₂O, Al(PO₃)₃LiF, P₂S₃, Li₂S, Li₃N, Li₁₄Zn(GeO₄)₄, Li_{3.6}Ge_{0.6}V_{0.4}O₄, LiTi₂(PO₄)₃, Li_{3.25}Ge_{0.25}P_{0.25}S₄, Li_{1.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂ (where 0≤x≤1 and 0≤y≤1).

According to an eighth variant of this first aspect, which is also compatible with the first, second, third, fourth, fifth, sixth and seventh variant thereof, said nanoparticles of an inorganic material P comprise nanoparticles composed of a core and a shell, the core being formed of said inorganic material P, whereas the shell is formed of another material, which is preferably organic, and even more preferably polymeric.

In a first sub-variant of this eighth variant, said shell is formed of a material which is an electronic conductor.

In a second sub-variant of this eighth variant, said shell is formed of a material which is an electronic insulator and a cation conductor, in particular a lithium ion conductor.

In a third sub-variant of this eighth variant, said shell is formed of a material which is an electronic conductor and a cation conductor, in particular a lithium ion conductor.

According to a ninth variant of this first aspect, which is also compatible with the first, second, third, fourth, fifth, sixth, seventh and eighth variant, said nanoparticles of an inorganic material P (or, in the case of the eighth variant, said core made of inorganic material P of said nanoparticles) were prepared in suspension by precipitation.

A second aspect of the invention is a method for manufacturing at least one dense layer in a lithium ion battery with a capacitance greater than 1 mA h, said method for manufacturing said dense layer being that according to the first aspect of the invention, with all the variants and all the sub-variants described in relation to this first aspect of the invention.

According to a first variant of this second aspect, said material P is selected such that said dense layer can function as an anode in a lithium ion battery.

According to a second variant of this second aspect, said material P is selected such that said dense layer can function as a cathode in a lithium ion battery.

According to a third variant of this second aspect, which is also compatible with the first and the second variant thereof, said material P is selected such that said dense layer can function as an electrolyte in a lithium ion battery.

A third aspect of the invention is a method for manufacturing at least one dense layer in a lithium ion battery with a capacitance greater than 1 mA h, said dense layer being capable of being obtained with the method according to the first aspect of the invention, with all the variants and all the sub-variants described in relation to this first aspect of the invention.

According to a first variant of this third aspect, said material P is selected such that said dense layer can function as an anode in a lithium ion battery.

According to a second variant of this third aspect, which is also compatible with the first variant thereof, said material P is selected such that said dense layer can function as a cathode in a lithium ion battery.

According to a third variant of this third aspect, which is also compatible with the first and the second variant thereof, said material P is selected such that said dense layer can function as an electrolyte in a lithium ion battery.

A fourth aspect of the invention is a method for manufacturing a lithium ion battery with a capacitance greater than 1 mA h, said battery comprising at least one dense electrode layer deposited with the method according to the first aspect of the invention, with all the variants and all the sub-variants described in relation to this first aspect of the invention, and wherein a porous layer intended to form the separator is also deposited, preferably using an electrolyte material according to the seventh variant of the first aspect of the invention.

According to a first variant of this fourth aspect, said porous layer is a mesoporous layer, preferably with a mesoporous volume between 25% and 75%, and even more preferably between 30% and 60%.

According to a second variant of this fourth aspect, which is also compatible with the first variant thereof, the method for depositing said porous layer is a method selected preferably in the group formed by: electrophoresis, a printing method, selected preferably from ink-jet printing and flexographic printing, and a coating method selected preferably from roll coating, curtain coating, doctor blade coating, slot-die coating, dip-coating, knowing that in any case, the deposition is carried out using a suspension of nanoparticle aggregates or agglomerates.

According to a third variant of this fourth aspect, which is also compatible with the first and second variant thereof, a concentrated suspension containing nanoparticle agglomerates is used for depositing said porous layer.

According to a fourth variant of this fourth aspect, which is also compatible with the first, second and third variant thereof, a colloidal suspension is used for depositing said porous layer comprising aggregates or agglomerates of nanoparticles of at least one inorganic material, of mean primary diameter D50 between 2 nm and 100 nm, preferably between 2 nm and 60 nm, said aggregates or agglomerates typically having a mean diameter D50 between 50 nm and 300 nm, and preferably between 100 nm and 200 nm.

According to a fifth variant of this fourth aspect, which is also compatible with the first, second, third and fourth variant thereof, said layer thus obtained is dried and it is consolidated, by pressing and/or heating, to obtain a porous layer, preferably mesoporous and inorganic.

According to a sixth variant of this fourth aspect, which is also compatible with the first, second, third, fourth and fifth variant thereof, said porous layer is deposited on said dense layer.

According to a seventh variant of this fourth aspect, which is also compatible with the first, second, third, fourth, fifth and sixth variant thereof, said dense layer is deposited on said mesoporous layer.

According to an eighth variant of this fourth aspect, which is also compatible with the first, second, third, fourth, fifth, sixth and seventh variant thereof, a second electrode layer is deposited on said porous layer.

According to a first sub-variant of this eighth variant, said second electrode layer is a dense electrode, deposited with a method according to the first aspect of the invention.

According to a second sub-variant of this eighth variant, said second electrode layer is a porous electrode, preferably prepared according to the method for preparing a porous separating layer in relation to this fourth aspect of the invention, and particularly according to the first, second, third, fourth, and fifth variant thereof, the separator material being replaced by a suitable electrode material, and preferably using an anode material or a cathode material according to the seventh variant of the first aspect of the invention.

According to a ninth variant of this fourth aspect, which is also compatible with the first, second, third, fourth, fifth, sixth, seventh and eighth variant thereof, said porous separating layer is impregnated with mobile lithium ion carrier liquid, which is preferably selected in the group formed by:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer rendered an ionic conductor by adding at least one lithium salt; and
a polymer rendered an ionic conductor by adding a liquid electrolyte, either in the polymer phase, or in the mesoporous structure, said polymer being preferably selected in the group formed by poly(ethylene oxide), poly(propylene oxide), polydimethylsiloxane, polyacrylonitrile, poly(methyl methacrylate), poly(vinyl chloride), poly(vinylidene fluoride), PVDF-hexafluoropropylene.

A fifth aspect of the invention is a dense layer capable of being obtained with the method according to the first aspect of the invention, with all the variants and all the sub-variants described in relation to this first aspect of the invention.

According to a first variant of this fifth aspect, said material P is selected such that said dense layer can function as an anode in a lithium ion battery.

According to a second variant of this fifth aspect, which is also compatible with the first variant thereof, said material P is selected such that said dense layer can function as a cathode in a lithium ion battery.

According to a third variant of this fifth aspect, which is also compatible with the first and the second variant thereof, said material P is selected such that said dense layer can function as an electrolyte in a lithium ion battery.

According to a fourth variant of this fifth aspect, which is also compatible with the first, second and third variant thereof, said dense layer has a density of at least 90% of the theoretical density, preferably at least 95% of the theoretical density, and even more preferably at least 96% of the theoretical density, and optimally at least 97% of the theoretical density.

A sixth aspect of the invention is a dense layer in a lithium ion battery capable of being obtained with the method according to the first aspect of the invention, with all the variants and all the sub-variants described in relation to this first aspect of the invention.

According to a first variant of this sixth aspect, said material P is selected such that said dense layer can function as an anode in a lithium ion battery.

According to a second variant of this sixth aspect, which is also compatible with the first variant thereof, said material P is selected such that said dense layer can function as a cathode in a lithium ion battery.

According to a third variant of this sixth aspect, which is also compatible with the first and the second variant thereof, said material P is selected such that said dense layer can function as an electrolyte in a lithium ion battery.

A seventh aspect of the invention is a lithium ion battery with a capacitance greater than 1 mA h, comprising at least one dense layer according to the fifth aspect of the invention, with all the variants and all the sub-variants described in relation to this fifth aspect of the invention.

According to a first variant of this seventh aspect, said battery comprises an anode which is a dense layer according to the fifth aspect of the invention.

According to a second variant of this seventh aspect, said battery comprises a cathode which is a dense layer according to the fifth aspect of the invention.

According to a third variant of this seventh aspect, said battery comprises an anode and a cathode which are dense layers according to the fifth aspect of the invention.

According to a fourth variant of this seventh aspect, said battery comprises an anode and a cathode and an electrolyte which are dense layers according to the fifth aspect of the invention.

According to a fourth variant of this seventh aspect, which is also compatible with the first, second and third variant thereof, said battery comprises a separator which is a porous layer according to the fourth aspect of the invention.

1-25. (canceled).

26. A method for manufacturing a lithium ion battery with a capacitance greater than 1 mA h, the method comprising:
depositing at least one dense layer to serve as an anode layer, and/or a cathode layer, and/or an electrolyte layer, the depositing including:
supplying a substrate and a suspension of non-agglomerated nanoparticles of a material P;
depositing a layer, on said substrate, using the suspension of non-agglomerated nanoparticles of the material P;
drying the deposited layer;
densifying the dried layer by mechanical compression and/or heat treatment, wherein the depositing of the layer on the substrate and the drying of the deposited layer are performed at least partially at the same time, or during a temperature ramp;
wherein the suspension of non-agglomerated nanoparticles of the material P comprises nanoparticles of the material P having a size distribution, of value D₅₀ such that:
a distribution of nanoparticles of the material P of a first size D1 between 20 nm and 50 nm, and nanoparticles of the material P of a second size D2 having a value D₅₀ at least five times less than that of D1, or
the distribution has a mean size of nanoparticles of the material P that is less than 50 nm, and a standard deviation to mean size ratio that is greater than 0.6.

27. The method of claim 26, wherein:
the nanoparticles of the material P of the first size D1 represent between 50 and 75% of a total mass of the nanoparticles, and
a mean diameter of the nanoparticles of the second size is at least one twelfth of that of the nanoparticles of the first size Dl.

28. The method of claim 26, wherein:
the suspension of non-agglomerated nanoparticles of the material P is obtained by using a monodisperse suspension of nanoparticles of the first size D1, and
the suspension of nanoparticles of the second size D2 is obtained by using a monodisperse suspension.

29. The method of claim 26, wherein the deposition of the dense thin layer is performed electrophoretically by: a dip-coating method, or an ink-jet printing method, or roll coating, or curtain coating, or doctor blade coating.

30. The method of claim 26, wherein the suspension of non-agglomerated nanoparticles of the material P has a viscosity, measured at 20° C., of between 20 cP and 2000 cP.

31. The method of claim 26, wherein the material P is an inorganic material selected from the group consisting of:
oxides LiMn₂O₄, Li₁₊ₓMn₂₋ₓO₄ where 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ where M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ where 0≤x<0.15, LiNi_{1/x}Co_{1/y}Mn_{1/z}O₂ where x+y+z=10;
phosphates LiFePO₄, LiMnPO₄, LiCoPO₄, LiNiPO₄, Li₃V₂(PO₄)₃; the phosphates of formula LiMM′PO₄, where M and M′ (M≠M′) are selected from Fe, Mn, Ni, Co, V;
all lithiated forms of chalcogenides that include: V₂O₅, V₃O₈, TiS₂, titanium oxysulphides (TiO_{y}S_{z} where z=2−y and 0.3≤y≤1), tungsten oxysulphides (WO_{y}S_{z} where 0.6<y<3 and 0.1<z<2), CuS, CuS₂, LiₓV₂O₅ where 0<x≤2, LiₓV₃O₈ where 0<x≤1.7, LiₓTiS₂ where 0<x≤1, titanium and lithium oxysulphides LiₓTiO_{y}S_{z} where z=2−y, 0.3≤y≤1, LiₓWO_{y}S_{z}, LiₓCuS, LiₓCuS₂;
carbon nanotubes, graphene, graphite;
lithiated iron phosphate having a formula LiFePO₄;
mixed silicon and tin oxynitrides (having a formula SiₐSn_{b}O_{y}N_{z} where a>0, b>0, a+b ≤2, 0<y≤4, 0<z≤3) (also known as SiTON), and SiSn_{0.87}O_{1.2}N_{1.72}; oxynitrides-carbides having a formula SiₐSn_{b}C_{c}O_{y}N_{z} where a>0, b>0, a+b≤2, 0<c<10, 0<y<24, 0<z<17;
nitrides of type SiₓN_{y} (where x=3 and y=4), SnₓN_{y} (where x=3 and y=4), ZnₓN_{y} (where x=3 and y=2), Li₃₋ₓMₓN (where 0≤x≤0.5 for M=Co, 0≤x≤0.6 for M=Ni, 0≤x≤0.3 for M=Cu); Si₃₋ₓMₓN₄ where M=Co or Fe and 0≤x≤3;
oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂;
composite oxides TiNb₂O₇ composed of between 0% and 10% by mass of carbon selected from graphene and carbon nanotubes;
compounds of general formula Li_{w}Ti₁₋ₓM¹ₓNb_{2-y}M²_{y}O_{7-z}M³_{z} where M¹ and M² are each at least one elements selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, and Sn, and M³ is at least one halogen, and where 0≤w≤5, 0≤x<1, 0≤y<2 and 0<z≤0.3;
garnets having a formula Li_{d}A¹ₓA²_{y}(TO₄), where A¹ represents a cation of degree of oxidation +II (Ca, Mg, Sr, Ba, Fe, Mn, Zn, Y, Gd); and where A² represents a cation of degree of oxidation +III (Al, Fe, Cr, Ga, Ti, La); and where (TO₄) represents an anion where T is an atom of degree of oxidation +IV, located at a centre of a tetrahedron formed by oxygen atoms, and where TO₄ represents a silicate or zirconate anion, in which all or part of the elements T of a degree of oxidation +IV are replaceable by atoms of a degree of oxidation +III or +V (Al, Fe, As, V, Nb, In, Ta); where d is between 4 and 8, x is between 2.8 and 3.2, y is between 1.9 and 2.1, and z is between 2.9 and 3.1;
garnets selected from: Li₇La₃Zr₂O₁₂; Li₆La₂BaTa₂O₁₂; Li_{5.5}La₃Nb_{1.75}In_{0.25}O₁₂; Li₅La₃M₂O₁₂ where M=Nb or Ta or a mixture thereof; Li₇₋ₓBaₓLa₃₋ₓM₂O₁₂ where 0≤x≤1 and M=Nb or Ta or a mixture thereof; Li₇₋ₓLa₃Zr₂₋ₓMₓO₁₂ where 0≤x≤2 and M=Al, Ga, or Ta or a mixture thereof;
lithiated phosphates selected from: lithiated phosphates of a type NaSICON, Li₃PO₄; LiPO₃; Li₃Al_{0.4}Sc_{1.6}(PO₄)₃ referred to as “LASP”; Li_{1.2}Zr_{1.9}Ca_{0.1}(PO₄)₃; LiZr₂(PO₄)₃; Li₁₊₃ₓZr₂(P₁₋ₓSiₓO₄)₃ where 1.8<x<2.3; Li₊₆ₓZr₂(P₁₋ₓBₓO₄)₃ where 0≤x≤0.25; Li₃(Sc₂₋ₓMₓ)(PO₄)₃ where M=Al or Y and 0<x<1; Li₁₊ₓMₓ(Sc)₂₋ₓ(PO₄)₃ where M=Al, Y, Ga or a mixture thereof and 0≤x≤0.8; Li₁₊ₓMₓ(Ga_{1-y}Sc_{y})₂₋ₓ(PO₄)₃ where 0≤x≤0.8; 0≤y≤1 and M=Al or Y or a mixture thereof; Li₁₊ₓMₓ(Ga)₂₋ₓ(PO₄)₃ where M=Al, Y or a mixture thereof and 0≤x≤0.8; Li₁₊ₓAlₓTi₂₋ₓ(PO₄)₃ where 0≤x≤1 referred to as “LATP”; or Li₁₊ₓAlₓGe₂₋ₓ(PO₄)₃ where 0≤x≤1 referred to as “LAGP”; or Li_{1+x+z}Mₓ(Ge_{1-y}Ti_{y})₂₋ₓSi_{z}P _{3-z}O₁₂ where 0≤x≤0.8 and 0≤y≤1.0 and 0≤z≤0.6 and M=Al, Ga or Y or a mixture thereof; Li_{3+y}(Sc₂₋ₓMₓ)Q_{y}P_{3-y}O₁₂ where M=Al and/or Y and Q=Si and/or Se, 0≤x≤0.8 and 0≤y≤1; or Li_{1+x+y}MₓSc₂₋ₓQ_{y}P_{3-y}O₁₂ where M=Al, Y, Ga or a mixture thereof and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂where 0≤x≤0.8, 0≤y≤1, 0≤z≤0.6 where M=Al or Y or a mixture thereof and Q=Si and/or Se; or Li₁₊ₓZr₂₋ₓBₓ(PO₄)₃ where 0≤x≤0.25; or Li₁₊ₓZr₂₋ₓCaₓ(PO₄)₃ where 0≤x≤0.25; or Li₁₊ₓM³ₓM₂₋ₓP₃O₁₂ where 0≤x≤1 and M³=Cr, V, Ca, B, Mg, Bi and/or Mo, M=Sc, Sn, Zr, Hf, Se, or Si, or a mixture thereof; or Li₁₊₂ₓCaₓZr₂₋ₓ(PO₄)₃ where 0≤x≤0.25;
lithiated borates selected from: Li₃(Sc₂₋ₓMₓ)(BO₃)₃ where M=Al or Y and 0≤x≤1; Li₁₊ₓMₓ(Sc)₂₋ₓ(BO₃)₃ where M=Al, Y, Ga or a mixture thereof and 0≤x≤0.8; Li₁₊ₓMₓ(Ga_{1-y}Sc_{y})₂₋ₓ(BO₃)₃ where 0≤x≤0.8, 0≤y≤1 and M=Al or Y; Li₁₊ₓMₓ(Ga)₂₋ₓ(BO₃)₃ where M=Al, Y or a mixture thereof and 0≤x≤0.8; Li₃BO₃, Li₃BO₃—Li₂SO₄, Li₃BO₃—Li₂SiO₄, Li₃BO₃—Li₂SiO₄—Li₂SO₄;
oxynitrides selected from Li₃PO₄₋ₓN_{2x/3}, Li₄SiO₄—xN_{2x/3}, Li₄GeO₄₋ₓN_{2x/3} where 0<x<4 or Li₃BO₃₋ₓN_{2x/3} where 0<x<3;
lithiated compounds based on lithium and phosphorus oxynitride, referred to as “LiPON”, in a form of LiₓPO_{y}N_{z} where x˜2.8 and 2y+3z˜7.8 and 0.16≤z≤0.4, compounds Li_{w}POₓN_{y}S_{z} where 2x+3y+2z=5=w, or compounds Li_{w}POₓN_{y}S_{z} where 3.2≤x≤3.8, 0.13≤y≤0.4, 0≤z≤0.2, 2.9≤w≤3.3, or compounds in a form of LiₜPₓAl_{y}OᵤNᵥS_{w} where 5x+3y=5, 2u+3v+2w=5+t, 2.9≤t≤3.3, 0.84≤x≤0.94, 0.094≤y≤0.26, 3.23≤u≤3.8, 0.13≤v≤0.46, 0≤w≤0.2;
materials based on lithium phosphorus or boron oxynitrides, referred to respectively as “LiPON” and LIBON”, also containing silicon, sulphur, zirconium, aluminium, or a combination of aluminium, boron, sulphur and/or silicon, and boron for materials based on lithium phosphorus oxynitrides;
lithiated compounds based on lithium, phosphorus and silicon oxynitride referred to as “LiSiPON”;
lithium oxynitrides of types LiBON, LiBSO, LiSiPON, LiSON, thio-LiSiCON, LiPONB (where B, P, and S represent respectively boron, phosphorus and sulphur);
lithium oxynitrides of the type LiBSO, including (1−x)LiBO₂−xLi₂SO₄ where 0.4≤x≤0.8;
lithiated oxides selected from Li₇La₃Zr₂O₁₂ or Li₅₊ₓLa₃(Zrₓ,A₂₋ₓ)O₁₂ where A=Sc, Y, Al, Ga and 1.4≤x≤2 or Li_{0.35}La_{0.55}TiO₃ or Li₃ₓLa_{2/3-x}TiO₃ where 0≤x≤0.16 (LLTO);
silicates selected from Li₂Si₂O₅, Li₂SiO₃, Li₂Si₂O₆, LiAlSiO₄, Li₄SiO₄, LiAlSi₂O₆;
anti-perovskite type solid electrolytes selected from: Li₃OA where A is a halide or halide mixture, at least one of the elements selected from F, Cl, Br, I, or a mixture thereof; Li₍₃₋ₓ₎M_{x/2}OA where 0<x≤3, M a is divalent metal, at least one element selected from Mg, Ca, Ba, Sr, or a mixture thereof, where A is a halide or halide mixture, at least one element selected from F, Cl, Br, I, or a mixture thereof; Li₍₃₋ₓ₎M³_{x/3}OA where 0 x 3, M³ is a trivalent metal, A is a halide or a halide mixture, at least one element selected from F, Cl, Br, I, or a mixture thereof; or LiCOX_{z}Y_{(1-z)}, where X and Y are halides or halide mixtures, and 0≤z≤1;
compounds La_{0.61}Li_{0.34}Ti_{2.94,} Li_{3.4}V_{0.4}Ge_{0.604,} Li₂O—Nb₂O₅, LiAlGaSPO₄; and
formulations based on Li₂CO₃, B₂O₃, Li₂O, Al(PO₃)₃LiF, P₂S₃, Li₂S, Li₃N, Li₁₄Zn(GeO₄)₄, Li_{3.6}Ge_{0.6}V_{0.404,} LiTi₂(PO₄)₃, Li_{3.25}Ge_{0.25}P_{0.25}S₄, Li_{0.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂ (where 0≤x≤1 and 0≤y≤1).

32. The method of claim 26, wherein the nanoparticles of the material P comprise nanoparticles composed of a core of the material P and a shell.

33. The method of claim 32, wherein the shell is formed of a material which is an electronic conductor.

34. The method of claim 32, wherein the shell is formed of a material which is an electronic insulator and a lithium ion conductor.

35. The method of claim 26, further comprising depositing a porous separator layer, the porous separator layer comprising an inorganic mesoporous layer with a mesoporous volume between 30% and 60%.

36. The method of claim 35, wherein depositing the porous separator layer is:
conducted using a suspension of nanoparticle aggregates or agglomerates, and
deposited from the group consisting of: electrophoresis, ink-jet printing, flexographic printing, roll coating, curtain coating, doctor blade coating, slot-die coating, and dip-coating, the deposition is carried out.

37. The method of claim 35, wherein depositing the porous separator layer is:
conducted using a colloidal suspension comprising aggregates or agglomerates of nanoparticles of at least one inorganic material,
the aggregates or agglomerates of nanoparticles of at least one inorganic material have a mean primary diameter D₅₀ of between 2 nm and 60 nm, and
the aggregates or agglomerates of nanoparticles of at least one inorganic material have a mean diameter D₅₀ between 100 nm and 200 nm.

38. The method of claim 35, further comprising, after depositing the porous separator layer:
drying the porous separator layer, and
consolidating the porous separator layer by pressing and/or heating.

39. The method of claim 35, wherein the porous separator layer is deposited on the at least one dense layer.

40. The method of claim 35, wherein the at least one dense layer is deposited on the porous separator layer.

41. The method of claim 35, further comprising impregnating the porous separator layer with a mobile lithium ion carrier liquid selected in the group consisting of:
an electrolyte composed of at least one aprotic solvent and at least one lithium salt;
an electrolyte composed of at least one ionic liquid or ionic polyliquid and at least one lithium salt;
a mixture of at least one aprotic solvent and at least one ionic liquid or ionic polyliquid and at least one lithium salt;
a polymer rendered an ionic conductor by adding at least one lithium salt; and
a polymer rendered an ionic conductor by adding a liquid electrolyte, either in the polymer phase, or in the mesoporous structure, the polymer being selected in the group consisting of poly(ethylene oxide), poly(propylene oxide), polydimethylsiloxane, polyacrylonitrile, poly(methyl methacrylate), poly(vinyl chloride), and poly(vinylidene fluoride), PVDF-hexafluoropropylene.

42. A lithium ion battery manufactured using the method of claim 26, the lithium ion battery having a capacitance greater than 1 mA h.

43. The lithium ion battery of claim 42, wherein the at lease one dense layer is the anode layer.

44. The lithium ion battery of claim 42, wherein the at lease one dense layer is the cathode layer.

45. The lithium ion battery of claim 42, wherein the at least one dense layer is the electrolyte layer.
